(19) United States
(12) Patent Application Publication
(10) Pub. No.: US 2010/0211943 A1
(43) Pub. Date: Aug. 19, 2010

(54) METHOD FOR SIMPLIFYING PROCESS FOR INSTALLING APPLICATION OF WINDOWS OPERATING SYSTEM

(75) Inventors: Tao Chu, Tianjin (CN); Tom Chen, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 12/372,851

(22) Filed: Feb. 18, 2009

(51) Int. Cl. G06F 9/445

(52) U.S. Cl. 717/174

(57) ABSTRACT

A method for simplifying a process for installing an application of a Windows operating system is applied. The method includes the following steps. An answer file is created, in which an installation profile is created according to an installation sequence of installation packages of the Windows operating system and a configuration file is created according to environment parameters of the Windows operating system. The answer file is loaded. An original Windows Preinstallation Environment Image (WIM) file is read, and is stored into a memory unit, and the original WIM file defined as a target WIM file. The answer file is added and modified into a Windows image file of the target WIM file. The target WIM file is initiated and an installation procedure of the Windows operating system is performed.

### BACKGROUND OF THE INVENTION

1. Field of Invention

The present invention relates to a method of installing an application in a computer, in particular, to a method of simplifying a process for installing an application in a Windows operating system, which simplifies an installation process of the application of the Windows operating system by modifying a Windows image file of a Windows Preinstallation Environment Image (WIM) file.

2. Related Art

The Windows Preinstallation Environment (Windows PE) was developed to reduce the dependency upon a DOS environment during the deployment of Windows, and also to provide a light Windows execution environment to computer system manufacturers as the deployment environment. Along with the popularization and rapid development of Windows, the DOS environment still plays an important role in the deployment and installation of Windows. The Windows installation optical disc is booted from the DOS environment, and many deployment tools of the manufacturers are still in the DOS edition. However, when the Windows is even more popular, and the drivers and applications have transferred to the Windows environment, it is unnecessary to install or deploy the Windows in the DOS environment.

In view of this, Microsoft engineers in the Windows Installation Department put forward a concept of a light Win32 execution environment, which is designed to load the environment into a computer after the computer is booted from the optical disc, so as to avoid the dependency upon the DOS environment during the deployment of the Windows. Later, the concept has been developed to the Windows PE. It can be read from the full name of the Windows PE, the technique shall produce “an environment required by the installation of Windows.” Since a variety of applications and drivers are developed under the Windows environment, and the Windows environment also becomes a platform familiar to developers, it is necessary for the Windows PE to produce the Windows environment.

Moreover, the Windows PE shall be a customized operating environment for a specific task. Although the current application of the Windows PE has gone beyond the expectation, the Windows PE is still applied in some limited tasks (such as installation or deployment). Therefore, the Windows PE is not required to be an environment integrating complete functions, and unnecessary elements may be removed from the Windows PE. Similarly, as the Windows PE is applied in some specific tasks, the functions of the Windows PE must be able to be customized by the manufacturers.

The conventional Windows operating system requires the user to execute corresponding operations according to the system prompts during the installation process, the installation process is not automatic and additional manual operations are required.

### SUMMARY OF THE INVENTION

In view of the above problems, the present invention is directed to a method for simplifying a process for installing an application in a Windows operating system, which simplifies an installation process of the Windows operating system.

Accordingly, the method for simplifying a process of installing an application of a Windows operating system in the present invention is adapted to install the application including a plurality of installation packages under an environment of the Windows operating system, and includes the following steps. An answer file including an installation profile and a configuration file of the Windows operating system is created. The answer file is loaded. An original Windows Preinstallation Environment Image (WIM) file is read, and is copied and stored into a memory unit, and the original WIM file is defined as a target WIM file. The answer file is added and modified to a Windows image file of the target WIM file. The modified target WIM file is initiated, and an installation procedure of the application of the Windows operating system is performed.

In the answer file, the installation profile is created according to an installation sequence of the installation packages, and the configuration file is created according to environment parameters of the Windows operating system. Moreover, the answer file may be any one selected from a group consisting of an Unattend.txt file, an Unattend.xml file, and an Autounattend.xml file.

The method of the present invention further includes adding and modifying the Windows image file under a Linux environment.

The method for simplifying a process for installing an application of a Windows operating system provided in the present invention is applied in the installation of the Windows operating system, so as to simplify the process of the application. Further, user operation is not required during the installation process, so the time and labor cost is reduced. In addition, the method is also applicable to different versions of the Windows operating system.

### BRIEF DESCRIPTION OF THE DRAWINGS

The present invention will become more fully understood from the detailed description given herein below for illustration only, and thus are not limitative of the present invention, and wherein:

FIG. 1 is a flow chart of a method for simplifying a process for installing an application of a Windows operating system according to an embodiment of the present invention;

FIG. 2 is a structural view of simplifying a process for installing a Windows image file of the Windows operating system according to an embodiment of the present invention; and

FIG. 3 is a flow chart of modifying the Windows image file of a target Windows Preinstallation Environment according to an embodiment of the present invention.

### DETAILED DESCRIPTION OF THE INVENTION

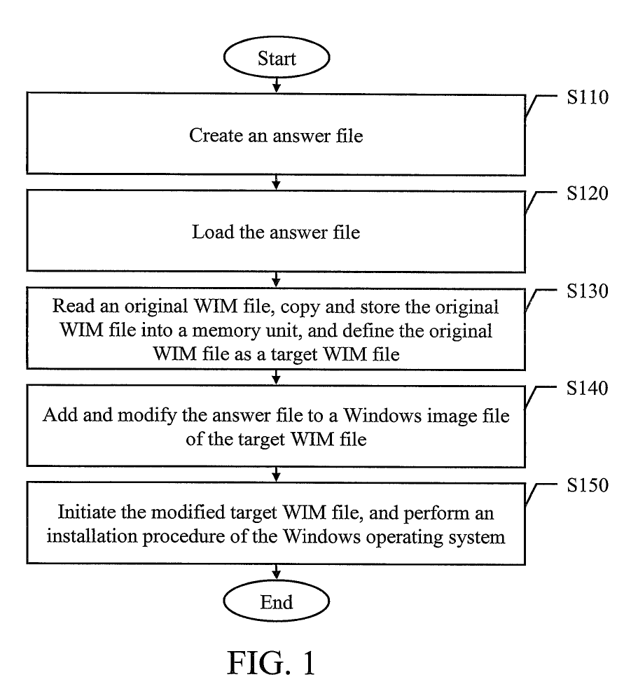

FIG. 1 is a flow chart of a method for simplifying a process for installing an application of a Windows operating system according to the present invention. The process of the present invention includes the following steps.

S110: an answer file including an installation profile and a configuration file of the Windows operating system is created, in which the installation profile is created according to an installation sequence of the installation packages, and the configuration file is created according to environment parameters of the Windows operating system;

S120: the answer file is loaded;

S130: an original Windows Preinstallation Environment image (WIM) file is read, and is copied and stored into a memory unit, and the original WIM file is defined as a target WIM file;

S140: the answer file is added and modified to a Windows image file of the target WIM file; and

S150: the modified target WIM file is initiated, and an installation procedure of the Windows operating system is performed.

The answer file may be any one selected from a group consisting of an Unattend.txt file, an Unattend.xml file, and an Autounattend.xml file, and a content of the answer file may be selectively supplemented as required.

In addition, Step S140 of adding and modifying the Windows image file is executed under a Linux environment.

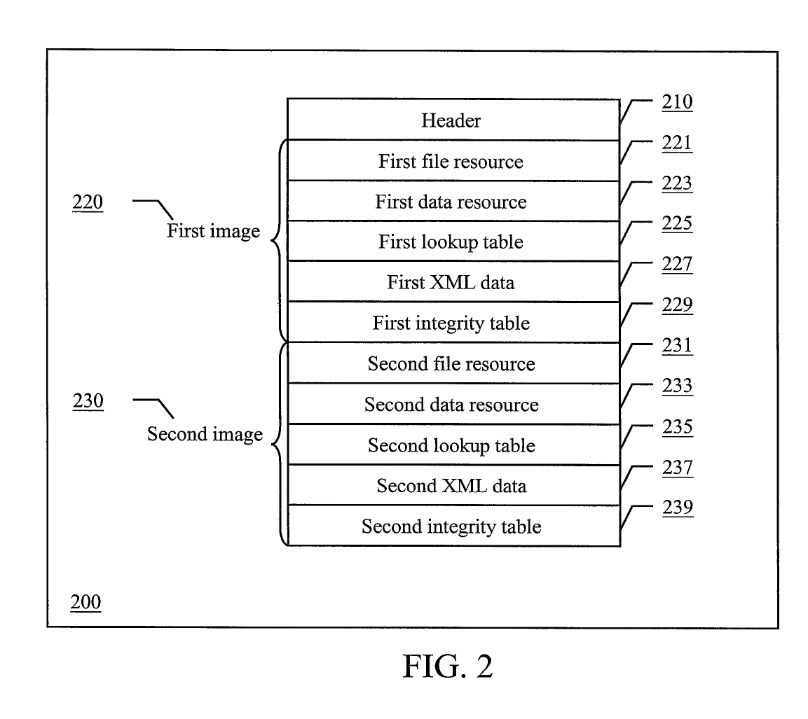

FIG. 2 is a structural view of simplifying a process for installing a Windows image file of the Windows operating system according to the present invention. Referring to FIG. 2, the Windows image file 200 includes a header 210, a first image 220, and a second image 230. The first image 220 further includes a first file resource 221, a first metadata resource 223, a first lookup table 225, a first XML (eXtensible Markup Language data) data 227, and a first integrity table 229. The second image 230 further includes a second file resource 231, a second metadata resource 233, a second lookup table 235, a second XML data 237, and a second integrity table 239.

Here, only the first image 220 and the second image 230 are described, but actually two or more images may also be used.

The header 210 defines the content of the Windows image file, including memory locations of critical resources (such as the metadata resources, lookup tables, and XML data) and attributes of the Windows image file (such as the version, size, and compression type). The first file resource 221 and the second file resource 231 may be a series of packages, including the retrieved data (such as a source file). The first metadata resource 223 and the second metadata resource 233 may be the file content information, including a directory structure and file attributes. The first image 220 and the second image 230 each have a metadata resource. The first lookup table 225 and the second lookup table 235 each include a memory location of the file resource of the Windows image file. The first XML data 227 and the second XML data 237 include the additional data of the Windows image file. The first integrity table 229 and the second integrity table 239 include security hash information for verifying the integrity of the first image 220 and the second image 230 during the application operation.

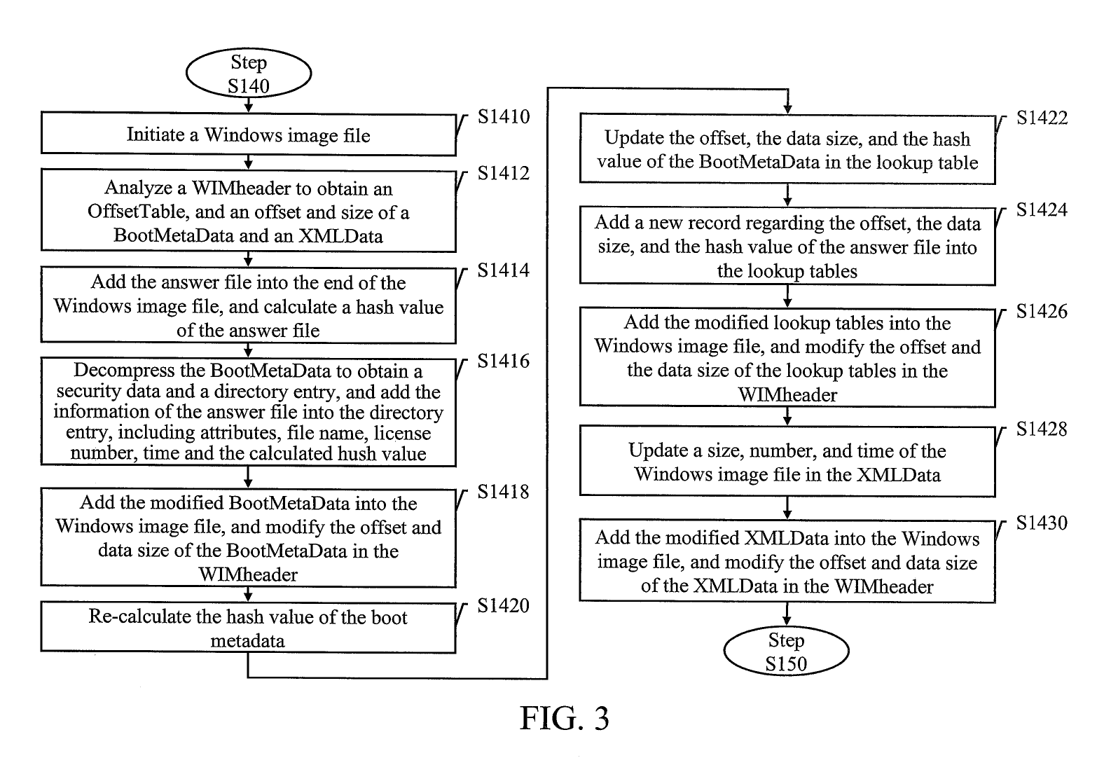

FIG. 3 is a flow chart of modifying the Windows image file of the target Windows Preinstallation Environment according to the present invention. Referring to FIG. 3, Step S140 of adding and modifying the Windows image file may be executed under a Linux environment, and may include the following steps.

S1410: a Windows image file is initiated;

S1412: a Windows image file header (WIMheader) is analyzed to obtain an OffsetTable, a BootMetaData, and an offset and size of an XMLData;

S1414: the answer file is added into the end of the Windows image file, and a hash value of the answer file is calculated;

S1416: the BootMetaData is decompressed to obtain a security data and a directory entry, and the information of the answer file is added into the directory entry, including attributes, a file name, a license number, a time and the calculated hush value;

S1418: the modified BootMetaData is added into the Windows image file, and the offset and data size of the BootMetaData in the WIMheader is modified;

S1420: the hash value of the BootMetaData is re-calculated;

S1422: the offset, the data size, and the hash value of the BootMetaData in the lookup tables are updated;

S1424: a new record regarding the offset, the data size, and the hash value of the answer file is added into the lookup tables;

S1426: the modified lookup tables are added into the Windows image file, and the offset and the data size of the lookup tables in the WIMheader are modified;

S1428: a size, number, and time of the Windows image file in the XMLData are updated; and

S1430: the modified XMLData is added into the Windows image file, and the offset and the data size of the XMLData in the WIMheader are modified.

Here, the hash value may be calculated through a Secure Hash Algorithm (SHA-1).

The data decompression method of the BootMetaData in Step S1416 may be executed through a Microsoft LZX Algorithm (LZX).

The data structures of the WIMheader, the security data, the directory entry, and the lookup table are listed below.

The data structure of the WIMheader is as follows.

typedef struct _WIMHEADER_V1_PACKED
{

| | |
|---|---|
| CHAR | ImageTag[8]; //“MSWIM\0\0” |
| DWORD | cbSize; |
| DWORD | dwVersion; |
| DWORD | dwFlags; |
| DWORD | dwCompressionSize; |
| GUID | gWIMGuid; |
| USHORT | usPartNumber; |
| USHORT | usTotalParts; |
| DWORD | dwImageCount; |
| RESHDR_DISK_SHORT | rhOffsetTable; |
| RESHDR_DISK_SHORT | rhXmlData; |
| RESHDR_DISK_SHORT | rhBootMetadata; |
| DWORD | dwBootIndex; |
| RESHDR_DISK_SHORT | rhIntegrity; |
| BYTE | bUnused[60]; |

}WIMHEADER_V1_PACKED,*LPWIMHEADER_V1_PACKED;

where, the RESHDR_DISK_SHORT in the above data structure has a data structure as follows:

| typedef struct _RESHDR_DISK_SHORT | |
|---|---|
| { | |
| RESHDR_BASE_DISK | Base; // Must be first. |
| LARGE_INTEGER | liOriginalSize; |

}RESHDR_DISK_SHORT, *LPRESHDR_DISK_SHORT;

where, the RESHDR_BASE_SHORT in the above data structure has a data structure as follows:

| typedef struct _RESHDR_BASE_DISK | |
|---|---|
| { | |
| ULONGLONG | ullSize; |
| LARGE_INTEGER | liOffset; |

}RESHDR_BASE_DISK, *LPRESHDR_BASE_DISK;

In addition, the data structure of the security data is as follows.

| typedef struct _SECURITYBLOCK_DISK | |
|---|---|
| { | |
| DWORD | dwTotalLength; |
| DWORD | dwNumEntries; |
| ULARGE_INTEGER | liEntryLength[0]; |

}SECURITYBLOCK_DISK, *LPSECURITYBLOCK_DISK;

In addition, the data structure of the directory entry is as follows.

| typedef struct _DIRENTRY | |
|---|---|
| { | |
| LARGE_INTEGER | liLength; |
| DWORD | dwAttributes; |
| DWORD | dwSecurityId; |
| LARGE_INTEGER | liSubdirOffset; |
| LARGE_INTEGER | liUnused1; |
| LARGE_INTEGER | liUnused2; |
| LARGE_INTEGER | liCreationTime; |
| LARGE_INTEGER | liLastAccessTime; |
| LARGE_INTEGER | liLastWriteTime; |
| BYTE | bHash[HASH_SIZE]; |
| DWORD | dwReparseTag; |
| LARGE_INTEGER | liHardLink; |
| USHORT | wStreams; |
| USHORT | wShortNameLength; |
| USHORT | wFileNameLength; |
| WCHAR | FileName[0]; |

}DIRENTRY, *LPDIRENTRY;

Finally, the data structure of the lookup table is as follows.

| typedef struct _RESHDR_DISK | |
|---|---|
| { | |
| RESHDR_DISK_SHORT | DiskShort; |
| USHORT | usPartNumber; |
| DWORD | dwRefCount; |
| BYTE | bHash[HASH_SIZE]; |

}RESHDR_DISK, *LPRESHDR_DISK;

The present invention relates to a method for simplifying a process for installing an application of a Windows operating system, which may simplify the process for installing the Windows operating system by modifying the Windows image file of the Windows Preinstallation Environment under the Linux environment.

What is claimed is:

1. A method for simplifying a process for installing an application of a Windows operating system, for installing the application comprising a plurality of installation packages under an environment of the Windows operating system, the method comprising:
creating an answer file comprising an installation profile and a configuration file of the Windows operating system, wherein the installation profile is created according to an installation sequence of the installation packages, and the configuration file is created according to environment parameters of the Windows operating system;
loading the answer file;
reading an original Windows Preinstallation Environment Image (WIM) file, copying and storing the original WIM file to a memory unit, and defining the original WIM file as a target WIM file;
adding and modifying the answer file into a Windows image file of the target WIM file; and
initiating the modified target WIM file, and performing an installation procedure of the Windows operating system.

2. The method for simplifying a process for installing an application of a Windows operating system according to claim 1, wherein the answer file is any one selected from a group consisting of an Unattend.txt file, an Unattend.xml file, and an Autounattend.xml file.

3. The method for simplifying a process of installing an application of a Windows operating system according to claim 1, wherein the adding and modifying the Windows image file are executed under a Linux environment.
